(19) United States
(12) Patent Application Publication
(10) Pub. No.: US 2016/0335901 A1
(43) Pub. Date: Nov. 17, 2016

(54) CONTROL OF AUTONOMOUS ROTORCRAFT IN LIMITED COMMUNICATION ENVIRONMENTS

(71) Applicant: Near Earth Autonomy, Inc., Pittsburgh, PA (US)

(72) Inventors: Sanjiv Singh, Pittsburgh, PA (US); Bradley Hamner, Pittsburgh, PA (US); Stephen Nuske, Pittsburgh, PA (US); Hugh Cover, Pittsburgh, PA (US); Lyle Chamberlain, Pittsburgh, PA (US)

(21) Appl. No.: 15/091,661

(22) Filed: Apr. 6, 2016

Related U.S. Application Data
(60) Provisional application No. 62/144,087, filed on Apr. 7, 2015.

(51) Int. Cl. G08G 5/02; G08G 5/00; G06T 7/00; G01S 17/02; G01C 21/16; G06K 9/00; G05D 1/10; G01S 17/88

(52) U.S. Cl. CPC G08G 5/025; G05D 1/101; G08G 5/0069; G01S 17/88; G01S 17/023; G01C 21/16; G06K 9/0063; G06T 7/0042; G06T 2207/30204; G06T 2207/10032; G06T 2200/04; G06T 2207/10024

(57) ABSTRACT

Navigation systems and methods communicate a landing location to an aircraft. The method comprises collecting data from multiple sensor systems of the aircraft over time while the aircraft is above the terrain. The method also comprises determining on-going pose estimates of the aircraft over time based on input data from the multiple sensor systems. The method further comprises detecting a non-natural marker in the image data from the camera system, with the non-natural marker being physically located on the terrain at a desired landing location for the aircraft. The method further comprises determining a bearing of the non-natural marker relative to the aircraft from the image data captured by the camera system. The method comprises determining a location of the non-natural marker in a global coordinate frame based on a 3D mapping of terrain below the aircraft and the determined bearing for the marker.

### PRIORITY CLAIM

The present application claims priority to U.S. provisional application Ser. No. 62/144,087, filed Apr. 7, 2015, which is incorporated herein by reference in its entirety.

### STATEMENT REGARDING GOVERNMENT RIGHTS

This invention was made with government support under Contract No. N00014-12-C-0671, awarded by Department of the Navy. The government has certain rights in the invention

### BACKGROUND

1. Field of the Invention

Various embodiments of the invention generally relate to tools, devices, and techniques for controlling and communicating with autonomous vehicles, such as autonomous rotorcraft, or pilot-assisted craft. In certain embodiments, the invention more particularly relates to ways to signal or communicate important flight-related information to an autonomous rotorcraft when there is limited radio communication ability between the autonomous rotorcraft and ground control station.

2. Introduction

An autonomous vehicle is a vehicle which can be operated with no human intervention or only limited amount of human interaction. Various types of autonomous or semi-autonomous vehicles may include cars, aircraft, or rotorcraft such as helicopters, for example, equipped with technology that allows the vehicle to operate independently or substantially independent of human involvement.

Rotorcraft may be used in a wide variety of tasks including cargo delivery, casualty evacuation, surveillance, people transport, and many others. In various scenarios, autonomous rotorcraft are often required to operate in cluttered, unknown, and unstructured environments. Because of the challenges posed by such environments, effective radio communication between the rotorcraft and the ground control system (or field operator) is important for successful deployment and operation of the rotorcraft.

For example, many military helicopter crashes are not caused by enemy action but are due to inadvertently or ineffectively controlled flight across the terrain. The problem arises from the fact that helicopters are useful in scenarios where they must operate close to terrain, vegetation, vehicles, and people, and in a variety of weather conditions. In addition, helicopters often create their own degraded visual environments during takeoff and landing, because the downwash from the rotors of the craft typically blows dust, snow, or other particles that can blind air crew and other ground personnel.

### SUMMARY

In one general aspect, the present invention is directed to navigation systems and methods of communicating a landing location to an aircraft traveling above terrain, particularly in a situation where radio communications to the aircraft are not operative (a “comms-out” condition). The method comprises the step of collecting data for multiple sensor systems of the aircraft over time, such as camera, lidar, GPS, and inertial navigation systems, while the aircraft is above the terrain. The method also comprises the step of determining, by a programmed, on-board computer system of the aircraft, on-going estimates of the position and orientation (“pose”) of the aircraft over time while the aircraft is above the terrain. The pose estimates are determined by on-board computer system based on input data from the multiple sensor systems of the aircraft. The method further comprises the step of detecting, by the on-board camera system, a non-natural marker in the image data from the camera system, with the non-natural marker being physically located on the terrain at a desired landing location for the aircraft. The method further comprises determining, by the on-board computer system, a bearing of the non-natural marker relative to the aircraft from the image data captured by the camera system. Additionally, the method comprises determining, by the on-board computer system, a location of the non-natural marker in a global coordinate frame based on a 3D mapping of terrain below the aircraft and the determined bearing for the marker.

In various implementations, the method may further comprise the step of generating, by the on-board computer system, the 3D mapping of the terrain based on, at least in part, the on-going pose estimates of the aircraft. The pose estimates may be determined based on the lidar and/or INS data, to the extent available. Similarly, the 3D mapping of the terrain may be generated in part based on the lidar data and/or the INS data, to the extent available. The method may also comprise, prior to the step of detecting the non-natural marker in the image data from the camera system, the step of physically placing the non-natural marker (e.g., a VS-17 panel) on the terrain at the landing location.

In various implementations, the aircraft can be an autonomous aircraft, in which case the method can further comprise the step of updating, by the on-board computer system, a flight plan of the autonomous aircraft based on the location of the non-natural marker in the global coordinate frame. Alternatively, the aircraft may be a piloted aircraft, in which case a monitor on the pilot control console of the aircraft can display the location of the non-natural marker to the pilot.

As described herein, embodiments of the present invention can be particularly useful and advantageous is situations where radio communications to the aircraft are out or deteriorated, yet an updated landing location needs to be communicated to the aircraft. These and other benefits of the present invention will be apparent from the description below.

### FIGURES

The discussion contained in the detailed description is associated with the accompanying figures, in which:

FIG. 1 schematically depicts an example of a flight system which can be employed in connection with different kinds of aircraft or rotorcraft;

FIG. 2 illustrates an example of a communicated signal positioned near the landing site of a rotorcraft;

FIG. 3 illustrates an example of how an object detection module can locate a colored panel within image data communicated from a camera;

FIG. 4 schematically illustrates an example of data flow and processing through certain components of an example of a flight system;

FIG. 5 illustrates an example of a digital terrain map derived from lidar data and pose estimate data;

FIG. 6 schematically illustrates an example of a rotorcraft detecting a communicated signal at a landing location;

FIG. 7 illustrates an example of certain components of a flight system configured to cover for the absence of lidar data; and,

FIG. 8 illustrates an example of certain components of a flight system configured to cover for the absence of GPS data.

This patent or application file contains at least one drawing executed in color. Copies of this patent or patent application with color drawings will be provided by the Office upon request and payment of the necessary fee.

### DESCRIPTION

In various embodiments, the present invention provides processes, tools, and techniques that can operate in conjunction with a visual signal to guide an autonomous vehicle (e.g., aircraft or rotorcraft) to a safe landing location. Such technology can be employed in situations when wireless radio communication (e.g., to inform the autonomous navigation system of the desired landing location) or other similar communication means are unavailable or not performing effectively in a given environment.

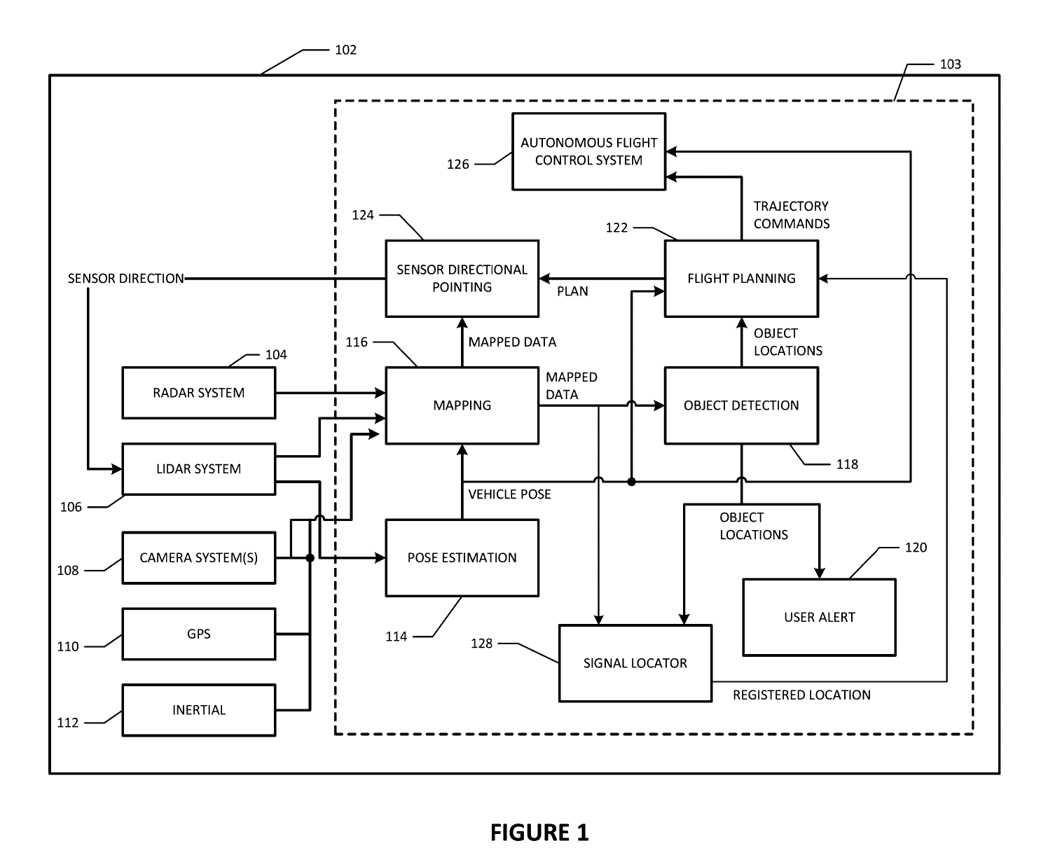

FIG. 1 schematically depicts an example of a flight system 102 which can be employed in connection with different kinds of aircraft or rotorcraft, for example, structured for autonomous or semi-autonomous operation. As shown, the flight system 102 includes various components which provide data to an on-board computer system 103 of the craft regarding its current operating conditions and its surrounding environment. A radar system 104 transmits high-frequency electromagnetic waves which are reflected from various objects in the environment around the craft and received back by the radar system 104 to determine the range, angle and/or velocity of the detected objects. A lidar system 106 may be incorporated into the system 102 which operates on similar principles to those of the radar system 104, but instead uses laser light or a focused beam of light to detect objects in the environment. The lidar data collected from the lidar system can be used to generate a high-resolution 3D map of the environment surrounding the craft. One or more cameras 108 may be employed by the system 102 to capture digital image data, for example, associated with the environment around the craft during flight. Also, a global positioning system or GPS system 110 may be provided for locating coordinates of the craft within a given space, such as latitude and longitude data, for example.

In certain embodiments, an inertial navigation system 112 (INS) may be employed as a navigation technique which employs measurements provided by accelerometers and gyroscopes, for example, to track the position and orientation of the craft relative to a known starting point, orientation and velocity. The INS 112 may include some combination of orthogonal rate gyroscopes, orthogonal accelerometers for measuring linear acceleration, or motion-sensing devices. The INS 112 may be provided with initial position and velocity data from another source, such as the GPS system 110, for example, and thereafter compute updated position and velocity data by integrating information received from its motion sensors. In various embodiments, the GPS system 110 and the INS system 112 can operate collaboratively as complementary systems. In certain embodiments, a combined GPS/INS system can be programmed to use GPS satellite signals to correct or calibrate a solution from an INS. The benefits of using GPS with INS also include providing position and angle updates at an enhanced rate than using GPS alone. Particularly with regard to dynamic vehicles such as aircraft and rotorcraft, the INS system 112 can fill in data gaps between detected GPS positions, for example. Also, if the GPS system 110 loses its signal, the INS system 112 can continue to compute position and angle data during the lost GPS signal period.

The on-board computer system 103 and the various sensor systems 104-112 loaded on-board or otherwise included on the craft, e.g., rotorcraft. All of these multiple sensor systems collect data over time as the aircraft flies or otherwise travels or hovers over the terrain below, and the data are time stamped so that the position and orientation of the aircraft at each time stamp can be estimated (as described below), and the time stamped pose estimates can be used to generate a 3D mapping of the terrain below the aircraft, along with the data from the radar, lidar, and camera systems 104, 106, 108, to the extent such data are available.

In various embodiments, data from the lidar system 106, the camera system 108, the GPS system 110, and/or the INS 112 are communicated to a pose estimation module 114 of the on-board computer system 103. The pose estimation module 114 can be programmed to determine the position and orientation (“pose”) of the craft including its latitude, longitude, altitude, and direction over time (e.g., time-stamped pose estimates). Information from the pose estimation module 114, along with data from the radar system 104 and the lidar system 106, can be communicated to a mapping module 116 of the on-board computer system 103. In certain embodiments, the mapping module 116 can be programmed to register data it receives into a global 3D space by determining where each data measurement it receives belongs in that 3D space. Data mapped by the mapping module 116 can then be communicated to an object detection module 118 of the on-board computer system 103 for determination of which mapped data represent an “object” of concern (e.g., wires, trees, buildings, bridges, etc.) and which mapped data do not comprise an object of concern. For example, the object detection module 118 may employ one or more different kinds of clustering algorithms for determining the presence of a curve shape which may be a power transmission line or a cable in the path of the craft. In various embodiments, the object detection module 118 can be programmed to determine and associate a location within the global space for each of the detected objects. Also, the object detection module 118 can filter out spurious data, such as caused by obscurants, such as dust, snow, etc. Also, the object detection module 118 could generate a dense 3D representation of the environment for the vehicle, such as a 3D grid in which every cell in the grid reports the likelihood that there is an object in that cell, regardless of whether the object is classified as a particular type of object or not. Certain flight planning modules (described below) may utilize such 3D representations. In certain embodiments, a user alert module 120 may be provided for providing an audible, visual, or other alert to an operator of the craft that an object of concern has been detected, for example.

A flight planning module 122 of the on-board computer system 103 may be programmed to receive data input from the object detection module 118 and/or the pose estimation module 114 to continually calculate (e.g., update) a flight path for the craft to follow during its flight. In the context of a fully autonomous rotorcraft, for example, the flight planning module 122 may automatically determine, and continuously update, a flight path or trajectory to follow with little or no human interaction. In various embodiments, a sensor directional pointing module 124 of the on-board computer system 103 may be programmed to receive flight plan data from the flight planning module 122 and/or mapped data from the mapping module 116. The sensor directional pointing module 124 operates to direct one or more of the sensors (e.g., the radar, lidar, and/or camera systems) in the direction where the craft is planning to travel in accordance with the flight plan. That is, the radar, lidar, and/or camera systems may each include mechanized systems for controlling in which directions the systems point in capturing data; for example, they can scan across the area in the impending flight path of the aircraft, including pointing toward the ground a substantial portion of the time. It can be appreciated that the sensor directional pointing module 124 provides a feedback loop (e.g., to the lidar system 106, etc.) for the process of obtaining updated data regarding objects which may arise in the path of the craft as it travels through an environment along the previously determined flight path. In various embodiments, an autonomous flight control system 126 of the on-board computer system 103 receives data input from the flight planning module 122 and/or the pose estimation module 114. The flight control system 126 may be programmed to execute the movement and general operation of the craft along the calculated flight plan, among performing other tasks. That is output from the flight control system 126 is used to control the propulsion and steering systems of the aircraft. The propulsion system(s) may include engines, motors, propellers, propulsive nozzles, and rockets, for example. The steering systems may include propeller blade pitch rotators, rudders, elevators, ailerons, etc.

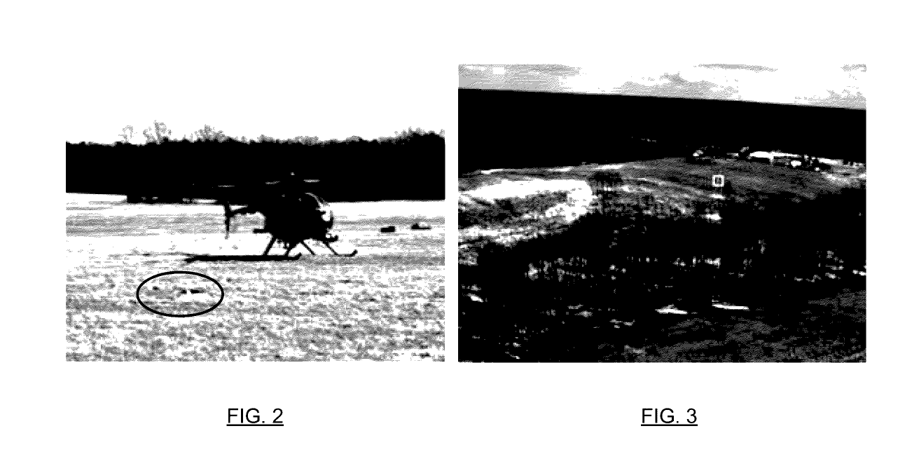

Various embodiments of the invention may combine electro-optical and/or infrared camera image data with lidar data, inertial data, GPS data, and/or digital terrain data to detect and georegister the location of a signal communicated to the craft. The signal can be from a man-made and/or non-natural indicator or marker in the environment of the vehicle that can be sensed by the vehicle. Here, “non-natural” means not naturally occurring in the present environment of the vehicle, such as indicators or markers that are positioned in the present environment of the vehicle by humans or robots, etc., and that are sensed by the camera system 108 or other sensing systems of the rotorcraft. Such signals may be from man-made and/or non-natural indicators such as brightly colored panels, for example, such as those shown in FIG. 2 (highlighted with a circle). In this example, brightly colored VS-17 panels can be positioned on the ground to signal the autonomous flight system of the craft where to land. VS-17 panels are brightly-colored panels, often pink and orange and often made of fabric, that are attached to articles or located on the ground and that need to be identified from the air.

As shown in FIG. 1, the on-board computer system may also include a signal locator module 128. The signal locator module 128 registers the location of the non-natural marker in the terrain map generated by the mapping module 116, and communicates the registered location of the marker in the map to the flight planning module 122, which can update the flight plan to use the registered location of the non-natural marker in landing the craft. FIG. 3 is an example image of terrain below a flying craft. The example of FIG. 3 illustrates how the object detection module 118 has identified the colored panel within image data communicated from the camera system 108 (highlighted in FIG. 3 with a square in about the center of the image). Examples of other man-made and/or non-natural indicators that can communicate such signals to the craft include smoke signals, infrared chemlights (e.g., glowsticks that emit infrared light energy), or many others. Depending on the nature of the communicated signal, the process of detecting the signal in the image may involve color segmentation, texture segmentation, gradient filtering, or a combination of these and other image processing techniques.

It can be appreciated that image data from the camera system 108 may provide information about the environment surrounding the autonomous craft in bearing only. That is, by detecting objects in a camera image, the flight system 103 may learn of their existence and their bearing relative to the camera system 108 (and hence the craft), but typically cannot determine the distance of the objects from the camera system (and hence the craft), and thus cannot georegister the location of the object. Alternatively, lidar data alone cannot detect the visual signals communicated to the craft. Lidar is usually focused in a small area and cannot provide range measurements to the entire scene in the same way that the camera provides a complete image of the scene every time it captures an image. Accordingly, in various embodiments of the present invention, the mapping module 116 registers lidar data with GPS/INS data (or a vehicle state estimation system that works differently than GPS but provides similar results) to generate a map of the terrain. Based on that map and the location (e.g., bearing) of the non-natural marker as determined by the objection detection module 118, the signal locator module 128 then registers objects detected in the camera images to that map, thus providing a landing location for the autonomous vehicle corresponding to the communicated signal.

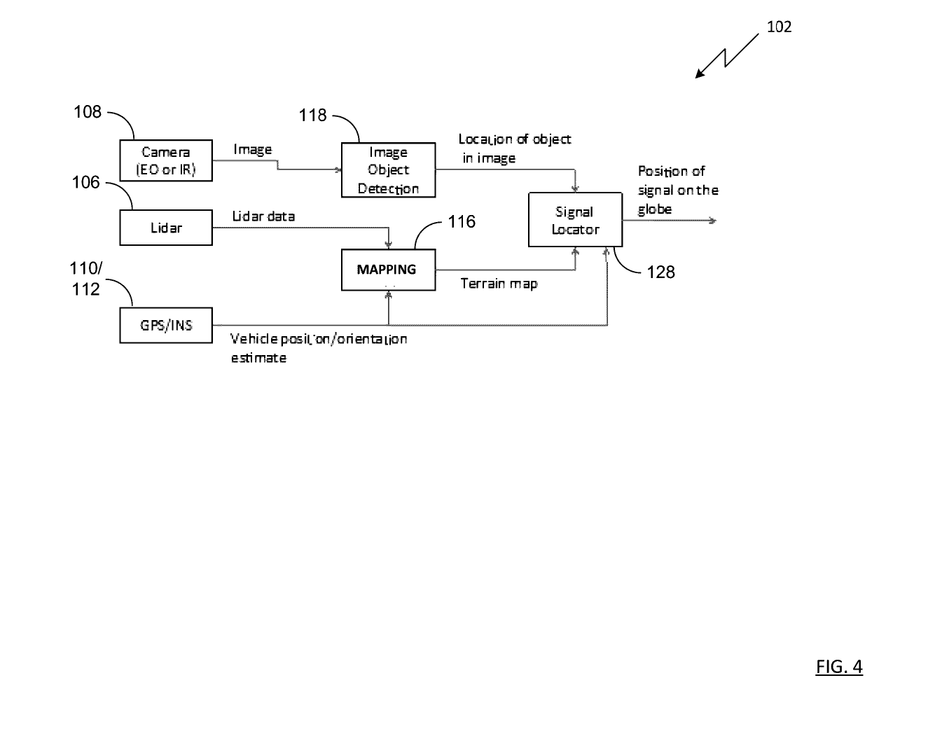

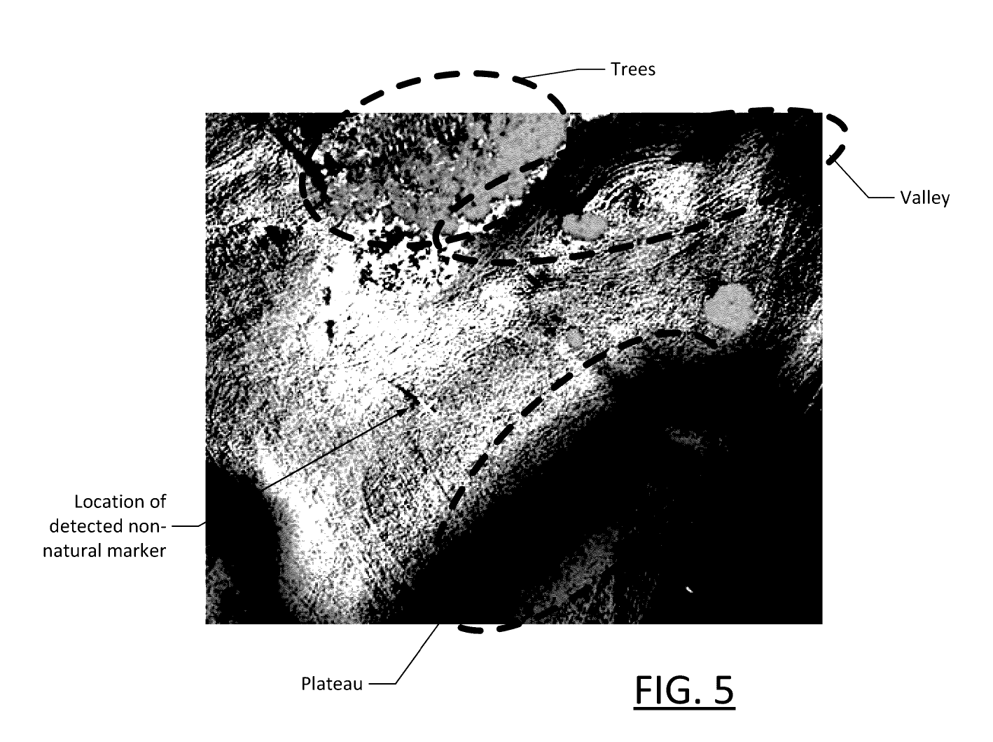

FIG. 4 outlines an example of data flow and processing through certain components of an example of a flight system 102. The object detection module 118 receives images from the camera system 108 and determines if a communicated signal is present in the image (such as the colored panel of FIG. 2). A mapping module 116 in the system 102 receives lidar range data from a lidar system 106 and an estimate of the position and orientation of the craft from a GPS/INS system 110/112 to generate a map of the terrain. An example of a digital terrain map derived from lidar data and pose estimate data is shown in FIG. 5. The map may be colored by height, with magenta the highest through color spectrum order to red as the lowest, in terms of elevation. Trees may be colored to appear as magenta, for example. A high plateau to the southeast (e.g., colored in blue) in the example of FIG. 5 leads down a slope towards a valley (e.g., colored in red) near a large cluster of trees in the north. The signal locator module 128 may be programmed to cross-reference the bearing to the communicated signal with the mapped terrain to derive a location of the signal in a global (3D) coordinate frame (as noted by the white “X” in FIG. 5).

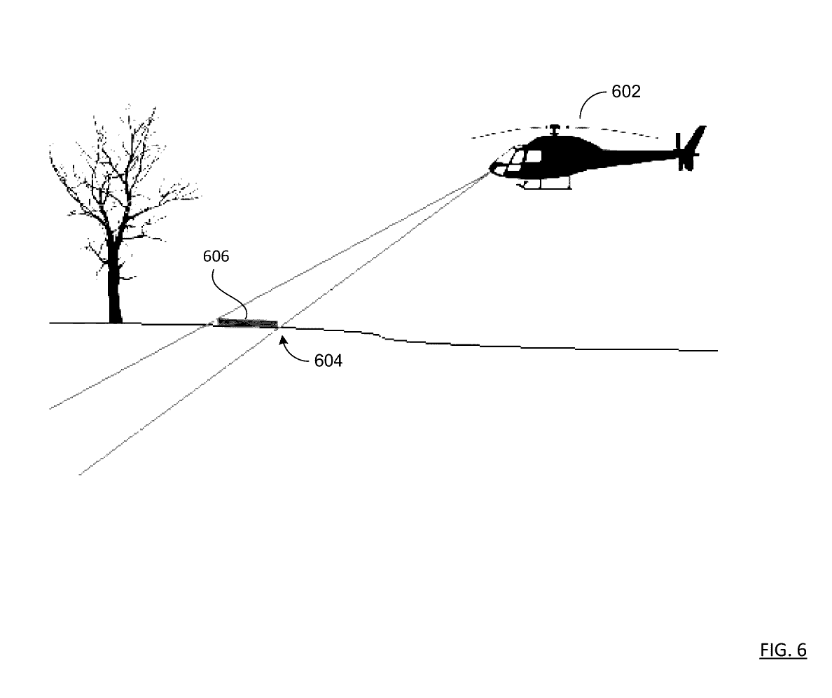

FIG. 6 illustrates an example of a rotorcraft 602 detecting a communicated signal at a landing location 604 of the signal. As the craft 602 approaches, the signal 606 (e.g., a rectangle colored pink) appears in the camera image data of the flight system. The image data from the camera supplies a bearing to the communicated signal, and the flight system can then intersect the bearing data with the mapped terrain to provide a global location of the signal. The flight planning module 122 can update the flight plan for the aircraft to direct it to the signal, and the updated flight plan can be input to the control system 126, which controls the propulsion and steering systems of the aircraft to the signal.

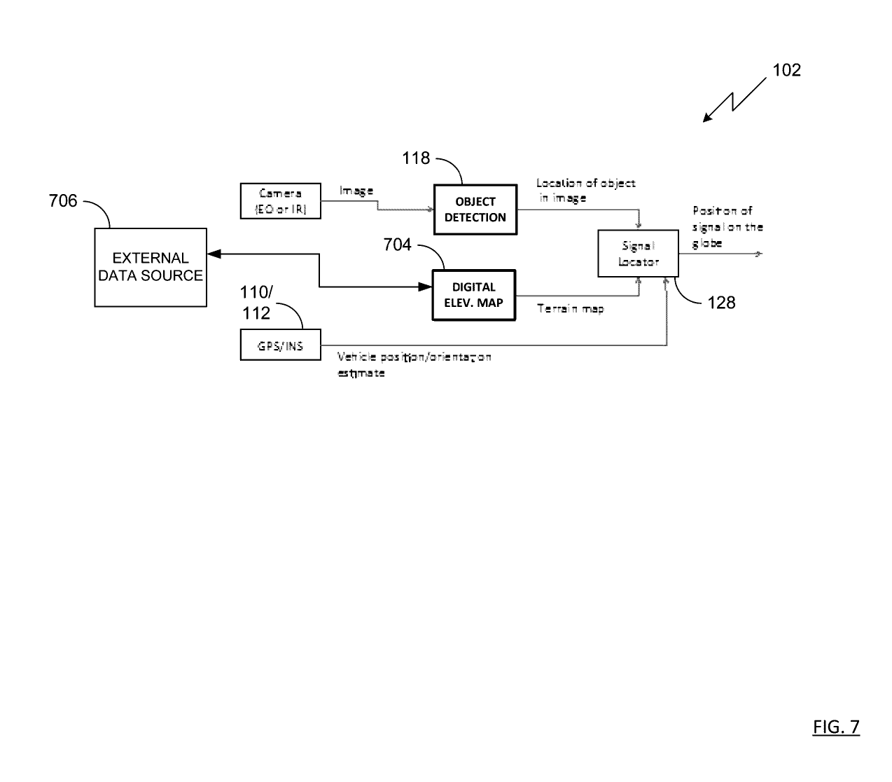

FIG. 7 illustrates an example of certain components of a flight system 102 configured to cover for the absence of the lidar system. In many cases, sensor data from components such as lidar and GPS are readily available. However, in the event that lidar data is not available, digital terrain data may be stored on an on-board digital elevation map (DEM) server 704. The terrain data for the digital elevation server 704 may be pre-loaded onto the digital elevation map server 704 from sources other than the craft's sensor systems 104-112, such as data obtained from the U.S. Geographical Survey, for example. The terrain map from such a digital elevation module 70 may be less accurate than a lidar-based system, since the terrain map could have lower resolution than provided by the lidar scanner, and due to the possibility that the terrain data may have changed since the map image data was last captured. In the event that lidar data are unavailable or the lidar system becomes inoperative or ineffective, then the terrain map from the digital elevation module 70 may be sufficient to provide a suitable proxy for the lidar data. For example, if the lidar data are not sufficiently dense, the mapping module 118 can conclude that the lidar system 106 is inoperative (at least for the time that the lidar data are not sufficiently dense, e.g., above a threshold) and, in that circumstance, the flight system 102 can use the terrain map from the digital elevation module 70.

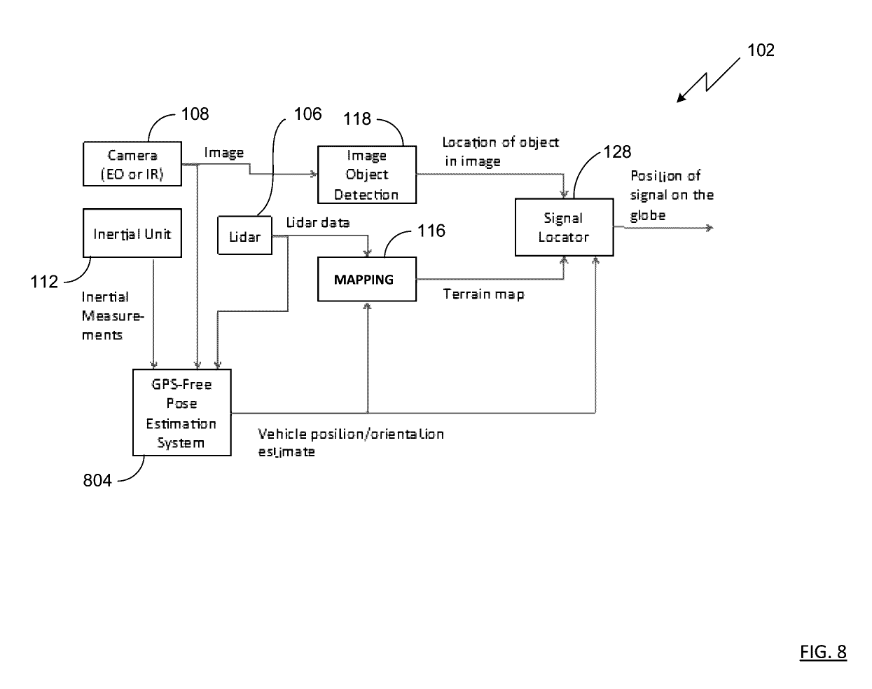

FIG. 8 illustrates an example of certain components of a flight system 102 configured to cover for the absence of the GPS system or GPS data. In the alternative embodiment shown, if GPS data are not available then a pose estimation system 804 can be substituted in place of the GPS system. The pose estimation system 804 may employ a combination of data inputs from the lidar system 106, the camera system 108 (which may comprise one or more cameras), and/or inertial measurements from the inertial unit 112 to determine a position and orientation of the craft. However, in the event that GP S data are unavailable or the GPS system becomes inoperative or ineffective, then the data from multiple sensors can be used in place of the GPS data to generate as estimate of the craft's pose by the pose estimation system 804.

In various embodiments, the flight system can use dynamic exposure adjustment to guarantee appropriately lighted images in an uncertain and changing lighting environment. The mapping module 116 may use advanced filtering to limit misregistration caused by GPS and lidar inaccuracies. It can be seen that the cross-reference between bearing information derived from image data and the terrain model is not simply a geometric calculation. Any object detected by the lidar above the terrain can alter the detected location of the communicated signal. In various embodiments, therefore, the mapping module 116 is programmed to filter out dust and other obscurants to increase the certainty that the lidar data being used are part of the terrain. Also, false positives (things which appear to be the signal, but are not really so) may be detected in the camera image. The signal locator module 128, therefore, can be programmed to track each detected signal and its georegistration against the terrain map, and then filter the location to improve accuracy and consistency. The signal locator module 128 can detect these attributes and remove false positives.

To this point, the description has been about how the man-made markers can be used to navigate autonomous rotorcraft, and why it is especially useful in situations where radio communications are out or limited (the “comms-out” situation). Aspects of the present invention could also be employed for non-autonomous aircraft with pilot-assist computer systems. Pilot-assist computer systems are computer systems on a pilot-commanded aircraft that automate some function of the pilot. In various embodiments, the pilot-assist computer system could include a camera system 108 and associated software (e.g., the post estimation module 114, the mapping module 116, the object detection module 118, and the signal locator module 128) for detecting (and locating) the man-made and/or non-natural marker on the ground, thereby relieving the pilot of the duty to locate the marker and allowing the pilot to attend to other requirements for safely flying the aircraft. In such piloted aircraft, when the location of the marker is determined, a monitor of the aircraft's console can visually inform the pilot of the location of the marker so that the pilot knows where to look to see the actual marker on the ground below. As such, the computer system 102 may be in communication with the monitor of the pilot's console.

In one general aspect, therefore, the present invention is directed to navigation systems and methods of communicating a landing location to an aircraft traveling above terrain. The method comprises the step of collecting data from the multiple sensor systems of the aircraft over time while the aircraft is above the terrain, including the collection of image data from the camera system of the terrain below the aircraft (e.g., not necessarily directly below, but below in terms of elevation and within the field of view of the generally downward-pointing camera and lidar systems). The method also comprises the step of determining, by a programmed, on-board computer system of the aircraft, on-going pose estimates of the aircraft over time based on input data from the multiple sensor systems, such as the lidar, GPS and inertial navigation systems. The method further comprises the step of detecting, by the on-board camera system, a non-natural marker in the image data from the camera system, with the non-natural marker being physically located on the terrain at a desired landing location for the aircraft. The method further comprises determining, by the on-board computer system, a bearing of the non-natural marker relative to the aircraft from the image data. Additionally, the method comprises determining, by the on-board computer system, a location of the non-natural marker in a global coordinate frame based on a 3D mapping of terrain below the aircraft and the determined bearing for the marker.

In various implementations, the method may further comprise generating, by the on-board computer system, the 3D mapping of the terrain below the aircraft based on, at least in part, the on-going pose estimates of the aircraft. The multiple sensor systems of the aircraft may comprise a lidar system and/or an INS. In such circumstances, the pose estimates may be determined based on the lidar and/or INS data, to the extent available. Similarly, the 3D mapping of the terrain may be generated in part based on the lidar data and/or the INS data, to the extent available. Alternatively, the 3D mapping of the terrain may comprise a pre-loaded digital elevation map (DEM) of the terrain. The method may also comprise, prior to the step of detecting the non-natural marker in the image data from the camera system, the step of physically placing the non-natural marker (e.g., a VS-17 panel) on the terrain at the landing location.

In various implementations, the aircraft is an autonomous aircraft, in which case the method can further comprise the step of updating, by the on-board computer system, a flight plan of the autonomous aircraft based on the location of the non-natural marker in the global coordinate frame. In addition, the aircraft could be a piloted aircraft, in which case a monitor on the control console of the aircraft can visually display the location of the non-natural marker to the pilot.

In another general aspect, the present invention is directed to a navigation system for communicating a landing location to an aircraft. The aircraft comprises the multiple sensor systems, including at least a camera system that captures image data over time of the terrain below the aircraft. The navigation system also comprises an on-board computer system that is in communication with the multiple sensor systems. The on-board computer system is programmed to determine on-going pose estimates of the aircraft over time while the aircraft is above the terrain, based on input data from the multiple sensor systems. The on-board computer system is also programmed to detect the non-natural marker in the image data from the camera system and to determine a bearing of the non-natural marker relative to the aircraft from the image data. The on-board computer system is also programmed to determine a location of the non-natural marker in a global coordinate frame based on a 3D mapping of terrain below the aircraft and the determined bearing for the marker.

In yet another general aspect, the present invention is directed to an aircraft that comprises propulsion means for propelling the aircraft and the above-described navigation system.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. For example, no particular aspect or aspects of the examples of system architectures, user interface layouts, or screen displays described herein are necessarily intended to limit the scope of the invention.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that a sufficient understanding of the present invention can be gained by the present disclosure, and therefore, a more detailed description of such elements is not provided herein.

The processes associated with the present embodiments may be executed by programmable equipment, such as computers, such as the on-board computer system 103. The on-board computer system 103 may comprise one or more computer devices, such as laptops, PCs, servers, etc. Where multiple computer devices are employed, they may be networked through wireless or wireless links, such as an Ethernet network. Each of the one or more computer devices of the computer system 103 comprises one or more processors and one or more memory units. The memory units may comprise software or instructions that are executed by the processor(s). The memory units that store the software/instructions that are executed by the processor may comprise primary computer memory, such as RAM. It may also be stored in secondary computer memory, such as diskettes, compact discs of both read-only and read/write varieties, optical disk drives, hard disk drives, solid state drives, or any other suitable form of secondary storage.

The modules described herein (e.g., the pose estimation module 114, the mapping module 116, the object detection module 118, the flight planning module 122, the sensor directional point module 124, the autonomous flight control system module 126, and the signal locator module 128) may be implemented as software code stored in a memory unit(s) of the on-board computer system 103 that is executed by a processor(s) of the on-board computer system 103. In various embodiments, the modules 114, 116, 118, 120, 122, 126 and 128 are part of a single on-board computer device (e.g., a single laptop, PC or server), and the digital elevation map module 704 in implemented with its own dedicated on-board server. In other embodiments, the modules 114, 116, 118, 120, 122, 126, 128 and 704 could be implemented with one or more on-board computer systems. The modules and other computer functions described herein may be implemented in computer software using any suitable computer programming language such as .NET, SQL, MySQL, HTML, C, C++, Python, and using conventional, functional, or object-oriented techniques. Programming languages for computer software and other computer-implemented instructions may be translated into machine language by a compiler or an assembler before execution and/or may be translated directly at run time by an interpreter. Examples of assembly languages include ARM, MIPS, and x86; examples of high level languages include Ada, BASIC, C, C++, C#, COBOL, Fortran, Java, Lisp, Pascal, Object Pascal, Haskell, ML; and examples of scripting languages include Bourne script, JavaScript, Python, Ruby, Lua, PHP, and Perl.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. Those of ordinary skill in the art will recognize that a sufficient understanding of the present invention can be gained by the present disclosure, and therefore, a more detailed description of such elements is not provided herein. Each of the individual embodiments described and/or illustrated herein has discrete components and features which may be readily separated from or combined with the features of any of the other several aspects without departing from the scope of the present disclosure. Any recited method can be carried out in the order of events recited or in any other order which is logically possible

While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

What is claimed is:

1. A method of communicating a landing location to an aircraft traveling above terrain, the method comprising:
collecting data by multiple sensor systems of the aircraft over time while the aircraft is above the terrain, wherein the multiple sensor systems comprise at least a camera system, and wherein collecting the data comprises capturing image data over time of the terrain below the aircraft;
determining, by a programmed, on-board computer system of the aircraft, on-going estimates of position and orientation (“pose”) of the aircraft over time while the aircraft is above the terrain, wherein the pose estimates are determined based on input data from the multiple sensor systems of the aircraft;
detecting, by the on-board camera system, a non-natural marker in the image data from the camera system, wherein the non-natural marker is physically located on the terrain at a landing location for the aircraft;
determining, by the on-board computer system, a bearing of the non-natural marker relative to the aircraft from the image data; and
determining, by the on-board computer system, a location of the non-natural marker in a global coordinate frame based on a 3D mapping of terrain below the aircraft and the determined bearing for the marker.

2. The method of claim 1, wherein:
the aircraft is an autonomous aircraft; and
the method further comprises updating, by the on-board computer system, a flight plan of the autonomous aircraft based on the location of the non-natural marker in the global coordinate frame.

3. The method of claim 1, further comprising generating, by the on-board computer system, the 3D mapping of the terrain below the aircraft based on, at least in part, the on-going pose estimates of the aircraft.

4. The method of claim 3, wherein:
the multiple sensor systems of the aircraft comprises a lidar system; and
generating the 3D mapping of the terrain comprises generating the 3D mapping of the terrain, by the on-board computer system, based in part on lidar data from the lidar system.

5. The method of claim 4, wherein determining the pose estimates of the aircraft comprise determining the pose estimates, by the on-board computer system, based in part on the lidar data from the lidar system.

6. The method of claim 3, wherein:
the multiple sensor systems of the aircraft comprises:
a lidar system; and
an inertial navigation system (INS);
determining the pose estimates of the aircraft comprises determining the pose estimates, by the on-board computer system, based in part on the lidar data from the lidar system and data from the INS; and
generating the 3D mapping of the terrain comprises generating, by the on-board computer system, the 3D mapping of the terrain based in part on lidar data from the lidar system and data from the INS.

7. The method of claim 1, wherein the 3D mapping of the terrain comprises a pre-loaded digital elevation map of the terrain.

8. The method of claim 1, wherein:
the aircraft comprises a piloted aircraft; and
a monitor of the aircraft displays the location of the non-natural marker to the pilot.

9. The method of claim 1, further comprising, prior to the step of detecting the non-natural marker in the image data from the camera system, physically placing the non-natural marker on the terrain at the landing location.

10. The method of claim 9, wherein the non-natural marker comprises a VS-17 panel.

11. A system for communicating a landing location to an aircraft traveling above terrain, the system comprising:
multiple sensor systems for collecting data over time as the aircraft travels above the terrain, wherein the multiple sensor systems comprise at least a camera system that captures image data over time of the terrain below the aircraft;
an on-board computer system that is in communication with the multiple sensor systems, wherein the on-board computer system is programmed to:
determine on-going estimates of position and orientation (“pose”) of the aircraft over time while the aircraft is above the terrain, wherein the pose estimates are determined based on input data from the multiple sensor systems;
detect a non-natural marker in the image data from the camera system, wherein the non-natural marker is physically located on the terrain at a landing location for the aircraft;
determine a bearing of the non-natural marker relative to the aircraft from the image data; and
determine a location of the non-natural marker in a global coordinate frame based on a 3D mapping of terrain below the aircraft and the determined bearing for the marker.

12. The system of claim 11, wherein:
the aircraft is an autonomous aircraft; and
the on-board computer system is further programmed to update a flight plan of the autonomous aircraft based on the location of the non-natural marker in the global coordinate frame.

13. The system of claim 11, wherein the on-board computer system is further programmed to generate the 3D mapping of the terrain below the aircraft based on, at least in part, the on-going pose estimates of the aircraft.

14. The system of claim 13, wherein:
the multiple sensor systems comprises a lidar system; and
the on-board computer system is programmed to generate the 3D mapping of the terrain based in part on lidar data from the lidar system.

15. The system of claim 14, wherein the on-board computer system is programmed to determine the pose estimates of the aircraft based in part on the lidar data from the lidar system.

16. The system of claim 13, wherein:
the multiple sensor systems comprise:
a lidar system; and
an inertial navigation system (INS);
the on-board computer system is programmed to:
determine the pose estimates of the aircraft comprise based in part on the lidar data from the lidar system and data from the INS; and
generate the 3D mapping of the terrain based in part on lidar data from the lidar system and data from the INS.

17. The system of claim 11, wherein the 3D mapping of the terrain comprises a pre-loaded digital elevation map of the terrain.

18. The system of claim 11, wherein:
the aircraft comprises a piloted aircraft; and
a monitor of the aircraft displays the location of the non-natural marker to the pilot.

19. An aircraft comprising:
propulsion means for propelling the aircraft; and
a navigation system that comprises:
multiple sensor systems for collecting data over time as the aircraft travels above the terrain, wherein the multiple sensor systems comprise at least a camera system that captures image data over time of the terrain below the aircraft;
an on-board computer system that is in communication with the multiple sensor systems, wherein the on-board computer system is programmed to:
determine on-going estimates of position and orientation (“pose”) of the aircraft over time while the aircraft is above the terrain, wherein the pose estimates are determined based on input data from the multiple sensor systems;
detect a non-natural marker in the image data from the camera system, wherein the non-natural marker is physically located on the terrain at a landing location for the aircraft;
determine a bearing of the non-natural marker relative to the aircraft from the image data;
determine a location of the non-natural marker in a global coordinate frame based on a 3D mapping of terrain below the aircraft and the determined bearing for the marker; and
determine control signals for the propulsion means based on the determined location of the non-natural marker.
